(19) United States
(12) Patent Application Publication
(10) Pub. No.: US 2016/0093264 A1
(43) Pub. Date: Mar. 31, 2016

(54) SHIFT REGISTER UNIT AND GATE DRIVE APPARATUS

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Honggang GU, Beijing (CN); Xiaohe LI, Beijing (CN); Hongmin LI, Beijing (CN); Xianjie SHAO, Beijing (CN); Qinghua JIANG, Beijing (CN)

(21) Appl. No.: 14/547,786

(22) Filed: Nov. 19, 2014

(30) Foreign Application Priority Data
Sep. 26, 2014 (CN) 201410502733.5

(51) Int. Cl. G09G 3/36

(52) U.S. Cl. CPC G09G 3/3696; G09G 2310/0289

(57) ABSTRACT

A shift register unit and a gate drive apparatus are disclosed. The shift register unit comprises a pre-charge module configured to provide a voltage of a first voltage source to a first node under the control of an input signal from the signal input terminal, the first node being an output node of the pre-charge module; a pull-up module, and configured to provide a clock signal from a first clock signal terminal to a signal output terminal under the control of a voltage of the first node; a reset module configured to provide a voltage of a second voltage source to the first node under the control of an input signal from a reset signal terminal; and a pull-down module configured to maintain the first node and the signal output terminal at a low level during non-operating time of the shift register unit.

### TECHNICAL FIELD

The present disclosure relates to a shift register unit and a gate drive apparatus.

### BACKGROUND

Thin Film Transistor-Liquid Crystal Displays (TFT-LCD) are widely used in various fields of production and living. When displaying, a TFT-LCD drives respective pixels in a display panel to display by a drive circuit. The drive circuit of a TFT-LCD mainly includes a gate drive circuit and a data drive circuit. The data drive circuit is used for, in accordance with clock signal timings, sequentially latching input data, converting the latched data into analog data and then inputting the same to data lines of the display panel. The gate drive circuit is generally implemented by a shift register which converts a clock signal into a turn-on/turn-off voltage to be output to respective gate lines of the display panel respectively. One gate line on the display panel is usually connected with one shift register unit (i.e. one stage of a shift register). Progressive scanning of pixels in the display panel is realized by making respective shift register units output turn-on voltages in an order. Such progressive scanning of pixels may be classified as unidirectional scanning and bidirectional scanning in terms of the scanning direction. Currently, in mobile products, in consideration of the promotion of capacity and yield of mobile products, usually, the bidirectional scanning is required.

On the other hand, with a development of panel display, high resolution and narrow frame become the trend of the development. With respect to this trend, GOA (Gate Driver on Array) technology appears. GOA technology integrates the gate drive circuit of the TFT-LCD directly on an array substrate to replace a drive chip spliced at the outer edge of the panel and made from a silicon chip. Since such technology may make the drive circuit directly on the array substrate, there is no need to splice IC and wire around the panel, reducing production procedures of the panel, lowering the product cost while improving the integration degree of the TFT-LCD panel, so that the narrow frame and the high resolution of the panel my be achieved. However, GOA technology has its inherent problems on service life, output stability and so on. In GOA design of an actual product, a key issue is how to realize a shift register function by using fewer circuit elements, and to reduce a noise at the output end so as to keep the gate drive circuit operating steady for a long term.

### SUMMARY OF THE DISCLOSURE

The present disclosure provides a shift register unit and a gate drive apparatus to eliminate a noise at the output end of the shift register unit and to improve the stability of operating.

According to one aspect of the present disclosure, there is provided a shift register unit, comprising: a pre-charge module, connected to a first voltage source and a signal input terminal, and configured to provide a voltage of the first voltage source to a first node under the control of an input signal from the signal input terminal, the first node being an output node of the pre-charge module; a pull-up module, connected to a first clock signal terminal, a signal output terminal and the first node, and configured to provide a clock signal from the first clock signal terminal to the signal output terminal under the control of a voltage of the first node; a reset module, connected to a second voltage source, a reset signal terminal and the first node, and configured to provide a voltage of the second voltage source to the first node under the control of an input signal from the reset signal terminal; and a pull-down module, connected to a third low voltage source, the first clock signal terminal, a second clock signal terminal, the first node and the signal output terminal, and configured to maintain the first node and the signal output terminal at a low level during non-operating time of the shift register unit.

According to another aspect of the present disclosure, there is provided a gate drive apparatus comprising a plurality of shift register units connected in series as mentioned above. Except for a first shift register unit and a last shift register unit in the plurality of shift register units connected in series, the signal output terminal of each of other shift register units is connected to the signal input terminal of a next shift register unit adjacent thereto and the reset signal terminal of a previous shift register unit adjacent thereto, the signal input terminal of the first shift register unit inputs a frame start signal, the signal output terminal thereof is connected to the signal input terminal of a second shift register unit, and the signal output terminal of the last shift register unit is connected to the reset signal terminal of a previous shift register unit adjacent thereto.

The shift register unit and the gate drive apparatus provided by embodiments of the present disclosure discharge noises at the first node and the signal output terminal continuously during the non-operating time of the shift register unit, so as to maintain the first node and the signal output terminal at a low level during the non-operating time, whereby improving the operating stability of the shift register unit and the gate drive apparatus.

### BRIEF DESCRIPTION OF THE DRAWINGS

FIG. 1 shows a functional block diagram of a shift register unit according to an embodiment of the present disclosure.

FIG. 2 shows a specific circuit structure diagram of a shift register unit according to an embodiment of the present disclosure.

FIG. 3 shows a schematic diagram of a gate drive apparatus formed of multiple shift register units in cascade according to an embodiment of the present disclosure.

FIG. 4 shows a time sequence chart when a shift register unit performs a forward scanning according to an embodiment of the present disclosure.

FIG. 5 shows a time sequence chart when a shift register unit performs a reverse scanning according to an embodiment of the present disclosure.

### DETAILED DESCRIPTION

In the following, technical solution in embodiments of the present disclosure will be described clearly and completely in conjunction with attached drawings in embodiments of the present disclosure. Apparently, the described embodiments are only a part of embodiments of the present disclosure, but not all the embodiments. Based on embodiments of the present disclosure, all other embodiments obtained by those ordinary skills in the art without any creative work belong to the protection scope of the present disclosure.

Transistors used in all the embodiments of the present disclosure may all be thin film transistor, field effect transistor or other devices with same properties. In the present embodiment, the connection manner of a drain electrode and that of a source electrode of each transistor may be interchanged, thus, in fact there is no difference between the drain electrode and the source electrode of respective transistor in embodiments of the present disclosure. Here, only for differentiating two electrodes other than a gate electrode of a transistor, one of them is referred to as the drain electrode and the other is referred to as the source electrode. And, it is provided according to forms in figures that the upper end of a transistor is the drain electrode and the lower end thereof is the source electrode.

FIG. 1 shows a functional block diagram of a shift register unit according to an embodiment of the present disclosure. As shown in FIG. 1, the shift register unit 100 includes: a pre-charge module 101, which is connected with a first voltage source and a signal input terminal INPUT and is configured to provide a voltage of the first voltage source to a first node PU under the control of an input signal from the signal input terminal INPUT, the first node PU is an output node of the pre-charge module; a pull-up module 102, which is connected with a first clock signal terminal, a signal output terminal OUTPUT and the first node PU and is configured to provide a clock signal from the first clock signal terminal to the signal output terminal OUTPUT under the control of a voltage of the first node PU; a reset module 103, which is connected with a second voltage source, a reset signal terminal RESET and the first node PU and is configured to provide a voltage of the second voltage source to the first node PU under the control of an input signal from the reset signal terminal RESET; and a pull-down module 104, which is connected with a third low voltage source VGL, a first clock signal terminal, a second clock signal terminal, the first node PU and the signal output terminal OUTPUT and is used to maintain the first node PU and the signal output terminal OUTPUT at low level during the non-operating time of the shift register unit 100.

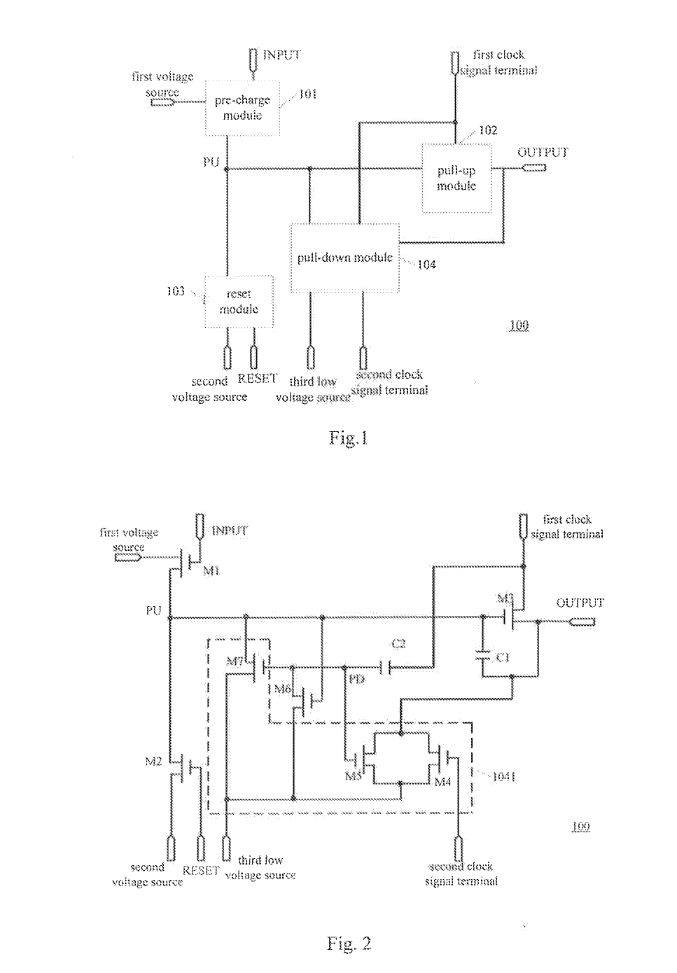

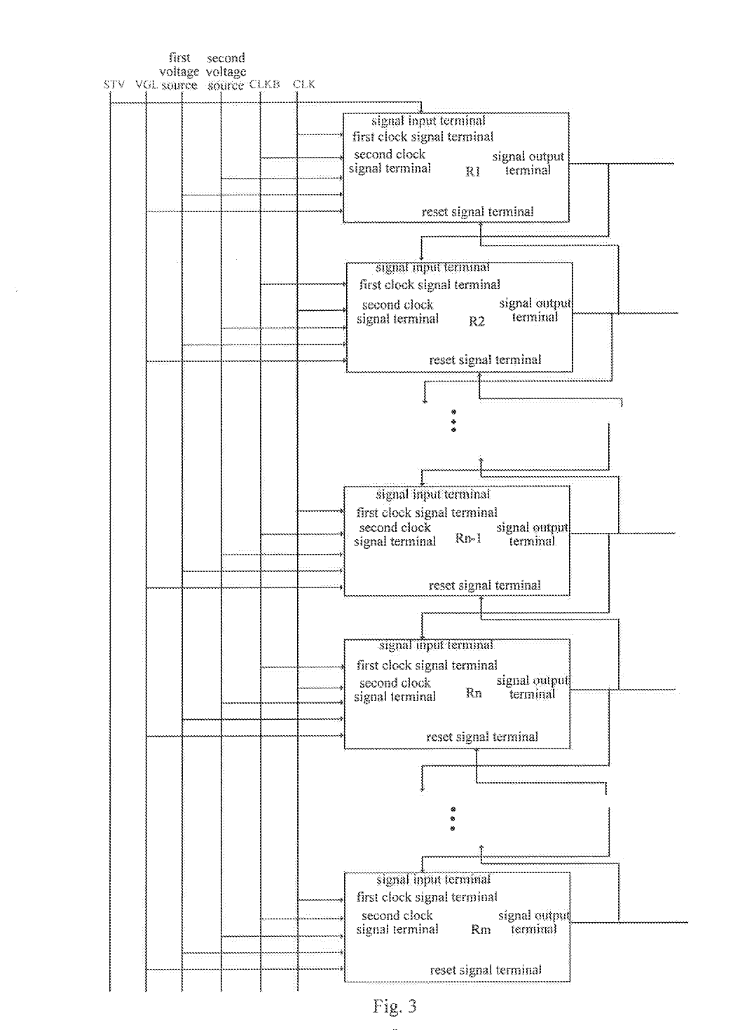

FIG. 2 shows a specific circuit structure diagram of the shift register unit shown in FIG. 1. As shown in FIG. 2, the pre-charge module 101 includes a first transistor M1, a gate of which is connected to the signal input terminal INPUT, a drain of which is connected to the first voltage source, and a source of which is connected to the first node PU.

The pull-up module 102 includes: a third transistor M3, a drain of which is connected to the first clock signal terminal, a gate of which is connected to the first node PU, and a source of which is connected to the signal output terminal OUTPUT; and a first capacitor C1 connected between the first node PU and the signal output terminal OUTPUT.

The reset module 103 includes a second transistor M2, a source of which is connected to the second voltage source, a drain of which is connected to the first node PU, and a gate of which is connected to the reset signal terminal RESET.

The pull-down module 104 includes: a second capacitor C2, one end of which is connected to the first clock signal terminal; a sixth transistor M6, a source of which is connected to the third low voltage source VGL, a gate of which is connected to the first node PU, and a drain of which is connected to the other end of the second capacitor C2 via a second node PD; a noise discharge module 1041, which is connected to the third low voltage source VGL, the second clock signal terminal, the first node PU, the second node PD and the signal output terminal OUTPUT, and is used for discharging noises at the first node PU and the signal output terminal OUTPUT during the non-operating time of the shift register unit 100.

In the pull-down module 104, the level at the second node PD is controlled by the second capacitor C2 and the sixth transistor M6, thereby controlling the noise discharge module 1041 to discharge noises at the first node PU and the signal output terminal OUTPUT. The noise discharge module 1041 may be implemented by adopting a variety of suitable electronic elements. For example, as shown in FIG. 2, as one exemplary implementation, the noise discharge module 1041 includes: a fourth transistor M4, a gate of which is connected to the second clock signal terminal, a drain of which is connected to the signal output terminal OUTPUT, and a source of which is connected to the third low voltage source VGL; a fifth transistor M5, a gate of which is connected to the second node PD, a drain of which is connected to the signal output terminal OUTPUT, and a source of which is connected to the third low voltage source VGL; a seventh transistor M7, a gate of which is connected to the second node PD, a drain of which is connected to the first node PU, and a source of which is connected to the third low voltage source VGL.

It is understood that the specific circuit structures of the pre-charge module 101, the pull-up module 102, the reset module 103, the pull-down module 104 and the noise discharge module 1041 shown in FIG. 2 are only an example and the respective modules may also use other suitable circuit structures as long as they can realize their own functions respectively, which is not limited by the present disclosure.

FIG. 3 shows a schematic diagram of a gate drive apparatus formed by multiple shift register units 100 as described above in cascade according to an embodiment of the present disclosure.

As shown in FIG. 3, in the gate drive apparatus, a plurality of shift register units 100 are connected in series, the signal output terminal OUTPUT of each of other shift register units Rn (1<n<m) except for the first shift register unit R1 and the last shift register unit Rm is connected with the signal input terminal INPUT of a next adjacent shift register unit Rn+1 and the reset signal terminal RESET of a previous adjacent shift register unit Rn−1. The signal input terminal INPUT of the first shift register unit R1 inputs a frame start signal STV, the signal output terminal OUTPUT thereof is connected with the signal input terminal INPUT of a second shift register unit R2. The signal output terminal OUTPUT of the last shift register unit Rm is connected with the reset signal terminal RESET of a previous adjacent shift register unit Rm−1.

In addition, as shown in FIG. 3, in the gate drive apparatus, clock signals input by the first clock signal terminals of shift register units of two adjacent stages are opposite to each other in phase, and clock signals input by the second clock signal input terminals thereof are opposite to each other in phase. For example, the first clock signal input terminal of the shift register unit R1 inputs a CLK signal, and the second clock signal input terminal thereof inputs a CLKB signal; the first clock signal input terminal of the shift register unit R2 inputs a CLKB signal, and the second clock signal input terminal thereof inputs a CLK signal, wherein the CLK signal and the CLKB signal are opposite to each other in phase.

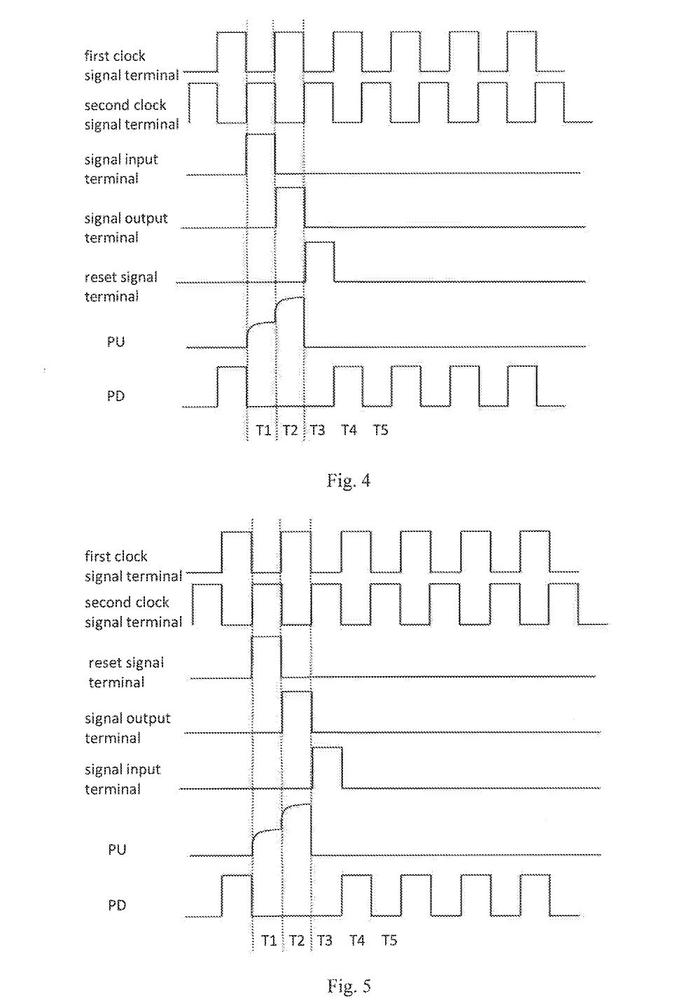

In the following, the detailed working procedure of the above said shift register unit 100 according to an embodiment of the present disclosure will be described with reference to FIGS. 4 and 5. First of all, to be clear, the above said shift register unit 100 according to an embodiment of the present disclosure is able to perform the bidirectional scanning. When performing a forward scanning and a reverse scanning, the structure of the shift register unit does not change, and only functions of the signal input terminal and reset signal terminal change, so that functions of the pre-charge module and the reset module are exchanged. Specifically, at the time of forward scanning, the first voltage source outputs a signal of a high level VDD, and the second voltage source outputs a signal of a low level VSS; at the time of reverse scanning, the first voltage source outputs the signal of the low level VSS, and the second voltage source outputs the signal of the high level VDD. The signal input terminal INPUT at the time of forward scanning functions as the reset signal terminal RESET at the time of reverse scanning, and the reset signal terminal RESET at the time of forward scanning functions as the signal input terminal INPUT at the time of reverse scanning.

First of all, the detailed working procedure of the shift register unit according to an embodiment of the present disclosure at the time of forward scanning is described in conjunction with the time sequence chart of forward scanning as shown in FIG. 4. Specifically, the working procedure includes five phases as follows.

A first phase T1: the signal input terminal INPUT of the shift register unit (Rn) inputs a high level signal, wherein the input signal of the signal input terminal INPUT is the output signal of the signal output terminal OUTPUT of the shift register unit (Rn−1) in the previous stage; in response to the inputted high level signal, transistor M1 is turned on, and at this time, the clock signal CLK of the first clock signal terminal is at the low level, and the first voltage source VDD charges the capacitor C1 through the transistor M1, so that the voltage of the first node PU is pulled up; the transistor M6 is turned on under the drive of the high potential at the node PU, whereby the second node PD is pulled to the low level VGL, and then transistors M5 and M7 are turned off; meanwhile, the clock signal CLKB of the second clock signal terminal is at the high level (as shown in FIG. 4, the clock signals CLKB and CLK are opposite to each other in phase), whereby transistor M4 is turned on, and thus discharges the noise at the signal output terminal OUTPUT, ensuring a stable signal output at the signal output terminal OUTPUT in the next phase.

A second phase T2: the input signal of the signal input terminal INPUT becomes at the low level, so that M1 is turned off and the first node PU continues to maintain the high level; at this time, the clock signal CLK of the first clock signal terminal becomes at the high level, the voltage at the first node PU is amplified due to bootstrapping, that is, the potential of one end of the capacitor C1 that is connected with the node PU continues to rise on the basis of the first phase, and the third transistor M3 keeps in a turned-on state, thus the high level signal inputted by the first clock signal terminal is transmitted to the signal output terminal OUTPUT via the third transistor M3, that is, a drive signal is transmitted to the signal output terminal OUTPUT; on the other hand, the node PU is at the high level at this time, so that M6 keeps in the turned-on state, causing M5 and M7 to continue to be turned off; meanwhile, the clock signal CLKB at the second clock signal terminal becomes at the low level, so that the transistor M4 is turned off, which keeps the high level signal outputted by the signal output terminal OUTPUT from being pulled down to the low level VGL, and ensures a stable output of the signal of the signal output terminal OUTPUT.

A third phase T3: the input signal of the reset signal terminal RESET becomes a high level signal, wherein the input signal is an output signal of the signal output terminal of the shift register unit (Rn+1) of the next stage, and the transistor M2 is turned on, so that the node PU is pulled down to the low level by the second voltage source VSS, thereby the transistor M3 is turned off, and the signal output terminal OUTPUT no longer transmits any drive signals, that is, the output end OUTPUT is shut down; meanwhile, the clock signal CLKB of the second clock signal terminal becomes at the high level, so that M4 is in the turned-on state, resetting the output signal terminal OUTPUT to the low level VGL.

A fourth phase T4: the clock signal CLK of the first clock signal terminal becomes at the high level. Since the node PU maintains at the low level at this time, M6 is in a turned-off state, the total quality of electric charge Q=CV on the capacitor C2 does not change, and the capacitance C is a constant, the node PD is pulled to the high level by the capacitor C2 in response to CLK becoming at the high level. In response to the node PD being at the high level, the transistor M5 becomes turned on, realizing the noise discharge of the signal output terminal OUTPUT, meanwhile the transistor M7 also becomes turned on, realizing the noise discharge of the node PU. With the noise discharge of this phase, the noise voltage which is produced mainly by the clock signal CLK can be eliminated, thereby low voltage output of the signal output terminal OUTPUT is realized and the stability of signal output is ensured.

A fifth phase T5: the clock signal CLK of the first clock signal terminal becomes at the low level. Since the node PU maintains at the low level at this time, M6 is in a turned-off state, the total quality of electric charge Q=CV on the capacitor C2 does not change, and the capacitance C is a constant, the node PD is pulled to the low level by the capacitor C2 in response to CLK becoming at the low level; in response to the node PD being at the low level, the transistors M5 and M7 are turned off; meanwhile, the clock signal CLKB of the second clock signal terminal becomes at the high level, so that the transistor M4 is turned on, realizing the noise discharge of the signal output terminal OUTPUT. With the noise discharge of this phase, the noise voltage which is produced mainly by the clock signal CLK can be eliminated, thereby low voltage output of the signal output terminal OUTPUT is realized and the stability of signal output is ensured.

Thereafter, the fourth and fifth phases as described above are repeated sequentially, noise discharging is performed on the node PU and the signal output terminal of the shift register unit continuously, until a next frame comes and the shift register unit receives the high level signal of the signal input terminal INPUT, and then the first phase as described above is performed again.

In the following, the detailed working procedure of the shift register unit according to an embodiment of the present disclosure at the time of reverse scanning is described in conjunction with the time sequence chart of reverse scanning as shown in FIG. 5. Specifically, the working procedure includes five phases as follows.

A first phase T1: the reset signal terminal RESET of the shift register unit (Rn) input a high level signal, wherein the input signal of the reset signal terminal RESET is the output signal of the signal output terminal OUTPUT of the shift register unit (Rn+1) in the next stage; in response to the inputted high level signal, transistor M2 is turned on, and at this time, the clock signal CLK of the first clock signal terminal is at the low level, and the second voltage source VDD charges the capacitor C1 through the transistor M1, so that the voltage of the first node PU is pulled up; the transistor M6 is turned on under the drive of the high potential at the node PU, whereby the second node PD is pulled to the low level VGL, and then transistors M5 and M7 are turned off; meanwhile, the clock signal CLKB of the second clock signal terminal is at the high level (as shown in FIG. 5, the clock signals CLKB and CLK are opposite to each other in phase), whereby transistor M4 is turned on, and thus discharge the noise at the signal output terminal OUTPUT, ensuring a stable signal output at the signal output terminal OUTPUT in the next phase.

A second phase T2: the input signal of the reset signal terminal RESET becomes at the low level, so that M2 is turned off and the first node PU continues to maintain the high level; at this time, the clock signal CLK of the first clock signal terminal becomes at the high level, the voltage at the first node PU is amplified due to bootstrapping, that is, the potential of one end of the capacitor C1 that is connected with the node PU continues to rise on the basis of the first phase, and the third transistor M3 keeps in a turned-on state, thus the high level signal inputted by the first clock signal terminal is transmitted to the signal output terminal OUTPUT via the third transistor M3, that is, a drive signal is transmitted to the signal output terminal OUTPUT; on the other hand, the node PU is at the high level at this time, so that M6 keeps in the turned-on state, causing M5 and M7 to continue to be turned off; meanwhile, the clock signal CLKB at the second clock signal terminal becomes at the low level, so that the transistor M4 is turned off, which keeps the high level signal outputted by the signal output terminal OUTPUT from being pulled down to the low level, and ensures a stable output of the signal of the signal output terminal OUTPUT.

A third phase T3: the input signal of the signal input terminal INPUT becomes a high level signal, wherein the input signal is an output signal of the signal output terminal of the shift register unit (Rn−1) of the previous stage, and the transistor M2 is turned on, so that the node PU is pulled down to the low level by the first voltage source VSS, thereby the transistor M3 is turned off, and the signal output terminal OUTPUT no longer transmits any drive signals, that is, the output end OUTPUT is shut down; meanwhile, the clock signal CLKB of the second clock signal terminal becomes at the high level, so that M4 is in the turned-on state, resetting the output signal terminal OUTPUT to the low level VGL.

A fourth phase T4: the clock signal CLK of the first clock signal terminal becomes at the high level. Since the node PU maintains at the low level at this time, M6 is in a turned-off state, the total quality of electric charge Q=CV on the capacitor C2 does not change, and the capacitance C is a constant, the node PD is pulled to the high level by the capacitor C2 in response to CLK becoming at the high level. In response to the node PD being at the high level, the transistor M5 becomes turned on, realizing the noise discharge of the signal output terminal OUTPUT, meanwhile the transistor M7 also becomes turned on, realizing the noise discharge of the node PU. With the noise discharge of this phase, the noise voltage which is produced mainly by the clock signal CLK can be eliminated, thereby low voltage output of the signal output terminal OUTPUT is realized and the stability of signal output is ensured.

A fifth phase T5: the clock signal CLK of the first clock signal terminal becomes at the low level. Since the node PU maintains at the low level at this time, M6 is in a turned-off state, the total quality of electric charge Q=CV on the capacitor C2 does not change, and the capacitance C is a constant, the node PD is pulled to the low level by the capacitor C2 in response to CLK becoming at the low level; in response to the node PD being at the low level, the transistors M5 and M7 are turned off; meanwhile, the clock signal CLKB of the second clock signal terminal becomes at the high level, so that the transistor M4 is turned on, realizing the noise discharge of the signal output terminal OUTPUT. With the noise discharge of this phase, the noise voltage which is produced mainly by the clock signal CLK can be eliminated, thereby low voltage output of the signal output terminal OUTPUT is realized and the stability of signal output is ensured.

Thereafter, the fourth and fifth phases as described above are repeated sequentially, noise discharging is performed on the node PU and the signal output terminal of the shift register unit continuously until a next frame comes and the shift register unit receives the high level signal of the reset signal terminal RESET, and then the first phase as described above is performed again.

It can be seen from the above description that, the shift register unit according to embodiments of the present disclosure continuously performs noise-discharging circularly on the signal output terminal OUTPUT and the first node PU during non-operating time, so that the signal output terminal OUTPUT and the node PU of the shift register unit always keep the low level except for the working time during which the shift register unit outputs a drive signal, thus, the noise at the output end is eliminated, the working stability is enhanced and the service life is extended; meanwhile, the shift register unit according to embodiments of the present disclosure employs fewer transistors therein, thus a narrow frame design of a liquid crystal display can be realized.

The described above is only specific embodiments of the present disclosure, but the protection scope of the present disclosure is not limited thereto, and changes and substitutions which can be easily thought of by any those skilled in the art within the technical scope disclosed by the present disclosure should all be contained within the protection scope of the present disclosure. Thus, the protection scope of the present disclosure should follow the protection scope of claims.

What is claimed is:

1. A shift register unit, comprising:
a pre-charge module, connected to a first voltage source and a signal input terminal, and configured to provide a voltage of the first voltage source to a first node under the control of an input signal from the signal input terminal, the first node being an output node of the pre-charge module;
a pull-up module, connected to a first clock signal terminal, a signal output terminal and the first node, and configured to provide a clock signal from the first clock signal terminal to the signal output terminal under the control of a voltage of the first node;
a reset module, connected to a second voltage source, a reset signal terminal and the first node, and configured to provide a voltage of the second voltage source to the first node under the control of an input signal from the reset signal terminal; and
a pull-down module, connected to a third low voltage source, the first clock signal terminal, a second clock signal terminal, the first node and the signal output terminal, and configured to maintain the first node and the signal output terminal at a low level during non-operating time of the shift register unit.

2. The shift register unit according to claim 1, wherein said pre-charge module comprises:
a first transistor, a gate of which is connected to the signal input terminal, a drain of which is connected to the first voltage source, and a source of which is connected to the first node.

3. The shift register unit according to claim 1, wherein said reset module comprises:
a second transistor, a source of which is connected to the second voltage source, a drain of which is connected to the first node, and a gate of which is connected to the reset signal terminal.

4. The shift register unit according to claim 1, wherein said pull-up module comprises:
a third transistor, a drain of which is connected to the first clock signal terminal, a gate of which is connected to the first node, and a source of which is connected to the signal output terminal; and
a first capacitor, connected between the first node and the signal output terminal.

5. The shift register unit according to claim 1, wherein said pull-down module comprises:
a second capacitor, one end of which is connected to the first clock signal terminal;
a sixth transistor, a source of which is connected to the third low voltage source, a gate of which is connected to the first node, and a drain of which is connected to the other end of the second capacitor via a second node; and
a noise discharge module, connected to the third low voltage source, the second clock signal terminal, the first node, the second node and the signal output terminal, and used for discharging noises at the first node and the signal output terminal during the non-operating time of the shift register unit.

6. The shift register unit according to claim 5, wherein said noise discharge module comprises:
a fourth transistor, a gate of which is connected to the second clock signal terminal, a drain of which is connected to the signal output terminal, and a source of which is connected to the third low voltage source;
a fifth transistor, a gate of which is connected to the second node, a drain of which is connected to the signal output terminal, and a source of which is connected to the third low voltage source; and
a seventh transistor, a gate of which is connected to the second node, a drain of which is connected to the first node, and a source of which is connected to the third low voltage source.

7. The shift register unit according to claim 1, wherein
at the time of forward scanning, the first voltage source outputs a high level signal, and the second voltage source outputs a low level signal;
at the time of reverse scanning, the first voltage source outputs the low level signal, and the second voltage source outputs the high level signal;
wherein, the signal input terminal at the time of forward scanning functions as the reset signal terminal at the time of reverse scanning, and the reset signal terminal at the time of forward scanning functions as the signal input terminal at the time of reverse scanning.

8. The shift register unit according claim 1, wherein the clock signal of the second clock signal terminal and the clock signal of the first clock signal terminal are opposite to each other in phase.

9. A gate drive apparatus comprising a plurality of shift register units connected in series, each of the shift register units comprising:
a pre-charge module, connected to a first voltage source and a signal input terminal, and configured to provide a voltage of the first voltage source to a first node under the control of an input signal from the signal input terminal, the first node being an output node of the pre-charge module;
a pull-up module, connected to a first clock signal terminal, a signal output terminal and the first node, and configured to provide a clock signal from the first clock signal terminal to the signal output terminal under the control of a voltage of the first node;
a reset module, connected to a second voltage source, a reset signal terminal and the first node, and configured to provide a voltage of the second voltage source to the first node under the control of an input signal from the reset signal terminal; and
a pull-down module, connected to a third low voltage source, the first clock signal terminal, a second clock signal terminal, the first node and the signal output terminal, and configured to maintain the first node and the signal output terminal at a low level during non-operating time of the shift register unit,
wherein except for a first shift register unit and a last shift register unit in the plurality of shift register units connected in series, the signal output terminal of each of other shift register units is connected to the signal input terminal of a next shift register unit adjacent thereto and the reset signal terminal of a previous shift register unit adjacent thereto,
the signal input terminal of the first shift register unit inputs a frame start signal, the signal output terminal thereof is connected to the signal input terminal of a second shift register unit, and the signal output terminal of the last shift register unit is connected to the reset signal terminal of a previous shift register unit adjacent thereto.

10. The gate drive apparatus according to claim 9, wherein
clock signals input by the first clock signal terminals of shift register units of two adjacent stages are opposite to each other in phase, and clock signals input by the second clock signal terminals thereof are opposite to each other in phase.

11. The gate drive apparatus according to claim 9, wherein said pre-charge module comprises:
a first transistor, a gate of which is connected to the signal input terminal, a drain of which is connected to the first voltage source, and a source of which is connected to the first node.

12. The gate drive apparatus according to claim 9, wherein said reset module comprises:
a second transistor, a source of which is connected to the second voltage source, a drain of which is connected to the first node, and a gate of which is connected to the reset signal terminal.

13. The gate drive apparatus according to claim 9, wherein said pull-up module comprises:
a third transistor, a drain of which is connected to the first clock signal terminal, a gate of which is connected to the first node, and a source of which is connected to the signal output terminal; and
a first capacitor, connected between the first node and the signal output terminal.

14. The gate drive apparatus according to claim 9, wherein said pull-down module comprises:
a second capacitor, one end of which is connected to the first clock signal terminal;
a sixth transistor, a source of which is connected to the third low voltage source, a gate of which is connected to the first node, and a drain of which is connected to the other end of the second capacitor via a second node; and
a noise discharge module, connected to the third low voltage source, the second clock signal terminal, the first node, the second node and the signal output terminal, and used for discharging noises on the first node and the signal output terminal during the non-operating time of the shift register unit.

15. The gate drive apparatus according to claim 14, wherein said noise discharge module comprises:
a fourth transistor, a gate of which is connected to the second clock signal terminal, a drain of which is connected to the signal output terminal, and a source of which is connected to the third low voltage source;
a fifth transistor, a gate of which is connected to the second node, a drain of which is connected to the signal output terminal, and a source of which is connected to the third low voltage source; and
a seventh transistor, a gate of which is connected to the second node, a drain of which is connected to the first node, and a source of which is connected to the third low voltage source.
